(19) United States
(12) Patent Application Publication
(10) Pub. No.: US 2025/0095093 A1
(43) Pub. Date: Mar. 20, 2025

(54) DEVICE INSTALLATION SUPPORT APPARATUS, METHOD, AND COMPUTER-READABLE MEDIUM

(71) Applicant: NEC Corporation, Minato-ku, Tokyo (JP)

(72) Inventor: Kazuki Ogata, Tokyo (JP)

(73) Assignee: NEC Corporation, Minato-ku, Tokyo (JP)

(21) Appl. No.: 18/727,137

(22) PCT Filed: Mar. 18, 2022
(86) PCT No.: PCT/JP2022/012800

§ 371 Date: Jul. 8, 2024

(51) Int. Cl. G06Q 50/26

(52) U.S. Cl. CPC G06Q 50/26

(57) ABSTRACT

Installation of device on a multifunction pole is supported. A registration means (11) registers, for a multifunction pole to be installed or already installed, recruitment information for recruiting addition of devices. A search means (12) searches the recruitment information registered by the registration means (11), and extracts a multifunction pole into which a device desired to be installed by a user or a module incorporating the device can be incorporated. The presentation means (13) presents the multifunction pole extracted by the search means (12) to the user.

### TECHNICAL FIELD

The present disclosure relates to a device installation support apparatus, a device installation support method, and a computer-readable medium.

### BACKGROUND ART

As a related art, Patent Literature 1 discloses a pole to which a device can be attached. The pole described in Patent Literature 1 includes a columnar support pillar and one or more coupling poles. The coupling pole has a cylindrical body. The cylindrical body includes a first connection portion provided at one end in a longitudinal direction, a second connection portion provided at the other end in the longitudinal direction, and a device attachment portion to which a device is attached. The first connection portion of each coupling pole is configured to be connectable to the second connection portion of another coupling pole. A device such as a lighting fixture, a security camera, a speaker, or an automatic blinker is attached to the device attachment portion of each coupling pole. In Patent Literature 1, by increasing or decreasing the number of coupling poles, the length of the poles and the number of devices to be attached can be increased or decreased. In addition, in Patent Literature 1, the function provided by the pole can be changed by replacing the device attached to the coupling pole.

### CITATION LIST

### Patent Literature

Patent Literature 1: Japanese Unexamined Patent Application Publication No. 2019-190002

### SUMMARY OF INVENTION

### Technical Problem

In the future, it is conceivable that more poles such as traffic lights and street lights are replaced by multifunction poles to which devices such as cameras and sensors are attached. In addition, it is considered that a business operator different from a business operator installing the multifunction pole can add a device to the multifunction pole. In that case, the business operator who wants to add the device needs to check where the multifunction pole to which the desired device can be added is installed, and the processing becomes complicated. Therefore, a mechanism for supporting a business operator who wants to add a device to the multifunction pole is desired.

In view of the above circumstances, an object of the present disclosure is to provide a device installation support apparatus, a device installation support method, and a computer-readable medium that can support installation of a device on a multifunction pole.

### Solution to Problem

In order to achieve the above object, the present disclosure provides, as a first aspect, a device installation support apparatus. The device installation support apparatus includes a registration means for registering, for a multifunction pole to be installed or installed, recruitment information for recruiting addition of a device to the multifunction pole, a search means for searching the recruitment information and extracting a multifunction pole into which a device desired to be installed by a user or a module incorporating the device can be incorporated, and a presentation means for presenting the extracted multifunction pole to the user.

The present disclosure provides, as a second aspect, a device installation support method. The device installation support method includes registering, for a multifunction pole to be installed or installed, recruitment information for recruiting addition of a device to the multifunction pole, searching the recruitment information and extracting a multifunction pole into which a device desired to be installed by a user or a module incorporating the device can be incorporated, and presenting the extracted multifunction pole to the user.

The present disclosure provides, as a third aspect, a computer-readable medium. The computer-readable medium stores a program for causing a computer to execute processing including registering, for a multifunction pole to be installed or installed, recruitment information for recruiting addition of a device to the multifunction pole, searching the recruitment information and extracting a multifunction pole into which a device desired to be installed by a user or a module incorporating the device can be incorporated, and presenting the extracted multifunction pole to the user.

### ADVANTAGEOUS EFFECTS OF INVENTION

The device installation support apparatus, the device installation support method, and the computer-readable medium according to the present disclosure can support device installation on a multifunction pole.

### BRIEF DESCRIPTION OF DRAWINGS

FIG. 1 is a block diagram illustrating a schematic configuration of a device installation support apparatus according to the present disclosure.

FIG. 2 is a block diagram illustrating a device installation support system including a device installation support apparatus according to an example embodiment of the present disclosure.

FIG. 3 is an exploded perspective view of a traffic light that is a multifunction pole as viewed from an oblique direction.

FIG. 4 is a block diagram illustrating a configuration example of a server.

FIG. 5 is a diagram illustrating an example of a screen displayed on a user terminal in search.

FIG. 6 is a view illustrating a display example of a search result.

FIG. 7 is a flowchart illustrating an operation procedure of the device installation support apparatus.

FIG. 8 is a block diagram illustrating a configuration example of a computer device.

### EXAMPLE EMBODIMENT

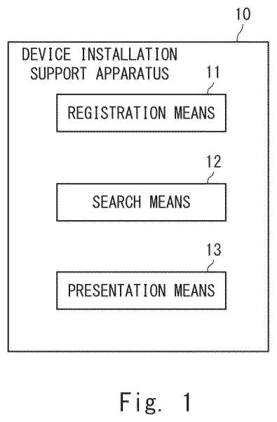

Prior to describing example embodiments of the present disclosure, an outline of the present disclosure will be described. FIG. 1 illustrates a schematic configuration of a device installation support apparatus according to the present disclosure. A device installation support apparatus 10 includes a registration means 11, a search means 12, and a presentation means 13.

The registration means 11 registers, for a multifunction pole to be installed or installed, recruitment information for recruiting addition of devices to the multifunction pole. The search means 12 searches the recruitment information, and extracts a multifunction pole into which a device desired to be installed by the user or a module incorporating the device can be incorporated. Here, the module means, for example, a part of the multifunction pole that is connected to another module to constitute the multifunction pole. The presentation means 13 presents the extracted multifunction pole to the user.

In the present disclosure, for example, in a case where a business operator who installs or manages the multifunction pole may incorporate devices or modules of other business operators into the multifunction pole, the business operator can register recruitment information in the device installation support apparatus 10. A user (business operator) who wishes to incorporate a device or a module into the multifunction pole can request the search means 12 to search for the multifunction pole into which the desired device or module is to be incorporated. The presentation means 13 presents the multifunction pole searched by the search means 12 to the user. In this manner, the device installation support apparatus according to the present disclosure can present a multifunction pole into which a device or a module can be incorporated to a user, and support installation of the device or the module on the multifunction pole.

Hereinafter, example embodiments of the present disclosure will be described in detail with reference to the drawings. Note that the following description and drawings are omitted and simplified as appropriate for clarity of description. In each drawing, the same elements and the same elements are denoted by the same reference numerals, and repeated description is omitted as necessary.

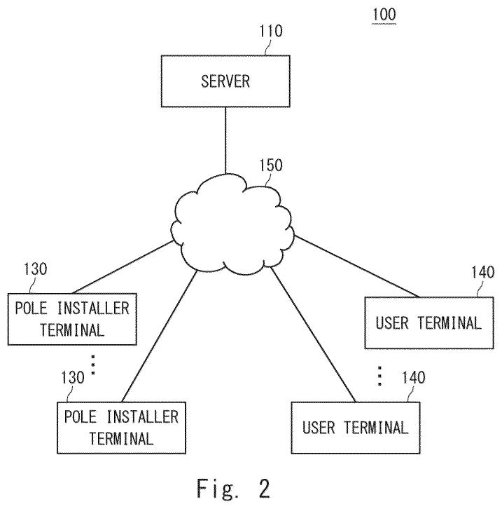

FIG. 2 illustrates a device installation support system including a device installation support apparatus according to an example embodiment of the present disclosure. A device installation support system 100 includes a server 110, one or more pole installer terminals 130, and one or more user terminals 140. The server 110, one or more pole installer terminals 130, and one or more user terminals 140 are connected to each other via a network 150 such as the Internet.

The pole installer terminal 130 is a terminal used by a business operator (hereinafter, also referred to as a pole installer) that installs the multifunction pole or manages the multifunction pole. The user terminal 140 is a terminal used by a business operator (hereinafter, also referred to as a device installation desiring person or a user) who wishes to install a device on the multifunction pole. The pole installer terminal 130 and the user terminal 140 are configured as information communication devices such as a personal computer (PC), a tablet, and a smartphone.

The multifunction pole will be described. In the present example embodiment, the multifunction pole refers to, for example, a pole in which a plurality of devices is installed or incorporated. The multifunction pole is formed by connecting a plurality of modules, for example. It is assumed that one or more devices can be incorporated in each module. The module used for the multifunction pole may also be referred to as a unit or an assembly (ASSY).

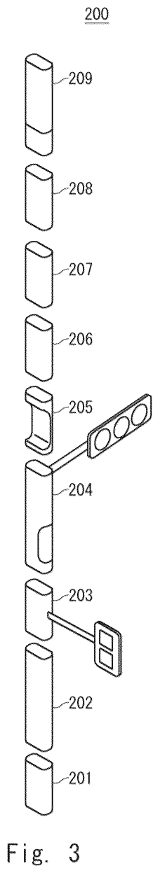

FIG. 3 is an exploded perspective view of a traffic light 200, which is a multifunction pole, as viewed from an oblique direction. The traffic light 200 has a plurality of modules 201 to 209 coupled to each other. Note that the multifunction pole is not necessarily configured as a traffic light, and may be configured as a pole having another function. For example, the multifunction pole may be a pole for illumination formed by coupling a plurality of modules. The traffic light 200 may be configured such that additional modules may be inserted at any location.

The module 201 is, for example, a module constituting a common unit. The module 201 internally includes devices such as a power supply device and a network device. The power supply device supplies power to the device mounted on the module 201 to 209. The network device is connected to an external network. The device mounted on the module 202 to 209 can be configured to be able to communicate with an external network through the network device of the module 201. Although the module 201 is not particularly limited, for example, at least a part thereof may be embedded in the ground. Alternatively, the module 201 may be connected to a foundation disposed on the ground by using a fastening bolt or the like. The module 201 may be coupled to a support pillar embedded in the ground.

The module 202 is, for example, a module having a function of digital signage. The module 202 includes, for example, a display and a control unit (controller). The module 202 may include a speaker and a microphone. Further, the module 202 may have an edge computer (MEC (Multi-access/Mobile Edge Computing) server).

The modules 203 and 204 are modules having a function of a traffic light. The module 203 is a module having a function of a pedestrian traffic light. The module 204 is a module having a function of a vehicle traffic light. The module 204 includes a body and a traffic signal lamp. The traffic signal lamp has blue, yellow, and red lamps. An arm of the traffic signal lamp is attached to the body via an attachment. A camera used for controlling the traffic signal lamp may be built in the body. The module 204 may have a traffic light control circuit inside the body to control the traffic signal lamp. The configuration of the module 203 having the function of a pedestrian traffic light may be similar to the configuration of the module 204 except that the traffic signal lamp is for pedestrians.

The module 205 is a module having a function of a security camera. The module 205 includes, for example, a camera that photographs the surroundings and a camera control circuit. The modules 206 and 207 are modules each having a device housing portion to which a device can be attached. A business operator (owner or installer) who installs the traffic light 200 or a business operator (administrator) who manages the traffic light 200 can give another business operator the right to use the device housing portions of modules 206 and 207. The other business operator who has acquired the right of use can incorporate a device having a desired function into the traffic light 200.

The module 208 is a module having a function of a public WiFi (registered trademark) base station. The module 208 includes, for example, a wireless antenna and a WiFi transceiver (wireless communication device). The module 209 is a module having a function of a 5G (5th Generation) antenna base station. The module 209 includes, for example, a wireless antenna and a 5G transceiver (wireless communication device). The communication method of the wireless communication function mounted on the traffic light 200 is not limited to 5G and public WiFi. The traffic light 200 may have a module including a wireless communication device of a communication system such as multi-channel access (MCA) advance or cellular vehicle to X (C-V2X).

Using the pole installer terminal 130, the pole installer registers, in the server 110, recruitment information for adding devices or recruiting use of the functions of the multifunction pole to be installed or already installed. The recruitment information includes, for example, location information of the multifunction pole. The recruitment information may include a condition of a device that can be incorporated into the multifunction pole, a condition of a module that can be incorporated into the multifunction pole, or both. Further, the recruitment information may include information indicating a function that can be provided by the multifunction pole, that is, a function that a device installed in the multifunction pole has and that an operator of the device permits provision to another business operator.

In the example of FIG. 3, in the traffic light 200, two modules 206 and 207 are empty modules on which no device is mounted. The pole installer can register, in the server 110, the recruitment information including the conditions of the devices that can be incorporated into each of the vacant modules. The conditions of the device that can be incorporated into the empty module include, for example, the size and weight of the device. The recruitment information may include a condition of a module that can be added to the traffic light 200. The condition of the module that can be added includes, for example, the size and weight of the module. In the traffic light 200, for example, when the functions of the module 208 (WiFi base station) and the module 209 (5G antenna base station) can be provided to other business operator, the recruitment information includes information indicating that the functions of the WiFi base station and the 5G antenna base station are available.

The user may request the server 110 to search for a multifunction pole that may incorporate desired devices or modules among the multifunction poles installed in various places. In the search request, the user can specify, for example, a condition of a place where the user wishes to install the device or the module. In addition, the user can specify the size and weight of the device or module desired to be installed in the search request. Further, in the search request, the user can specify a function that the user wants to use by being provided from the multifunction pole. The user can request a search from a webpage provided by the server 110, for example.

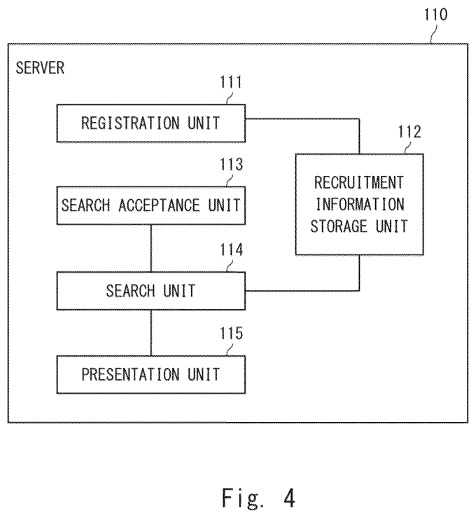

FIG. 4 illustrates a configuration example of the server 110. The server 110 includes a registration unit 111, a recruitment information storage unit 112, a search acceptance unit 113, a search unit 114, and a presentation unit 115. The server 110 includes one or more processors and one or more memories as a physical configuration. At least a part of the function of each unit in the server 110 can be realized by the processor executing processing according to a program read from the memory. In the present example embodiment, the server 110 corresponds to the device installation support apparatus 10 illustrated in FIG. 1.

The registration unit 111 receives the recruitment information from the pole installer terminal 130 (see FIG. 2). The registration unit 111 stores the recruitment information in the recruitment information storage unit 112. The registration unit 111 corresponds to the registration means 11 illustrated in FIG. 1. Note that the recruitment information storage unit 112 is not necessarily included in the server 110. The recruitment information storage unit 112 may be configured using, for example, a storage device connected to the server 110 via a network.

The search acceptance unit 113 accepts the search request transmitted from the user terminal 140. The search unit 114 searches the recruitment information stored in the recruitment information storage unit 112 according to the search request received by the search acceptance unit 113, and extracts one or more multifunction poles matching the request. For example, when a condition of an installation place of the device or the module is designated in the search request, the search unit 114 extracts a multifunction pole that meets the condition in which the location information is designated in the recruitment information.

For example, the user can specify a location of the multifunction pole and a form of the place a condition of the place. The user designates, for example, conditions such as an urban area, an intersection of two or more lanes on one side, the periphery of an elementary or junior high school, or the coast, in the search acceptance unit 113. In this case, the search unit 114 searches the recruitment information, and extracts the multifunction pole installed at the place meeting the condition. The user can designate a route on which the multifunction pole is installed as a condition of a place. The user designates, for example, a national highway X line or a prefectural road Y line. In this case, the search unit 114 retrieves the recruitment information, and extracts the multifunction pole installed on the national highway X line or the prefectural road Y line.

The user may specify characteristics of traffic participants at a location where the multifunction pole is installed, such as an intersection, as a condition of the place. The user specifies, for example, traffic characteristics such as a large number of two-wheeled vehicles, a large number of pedestrians, or a large amount of traffic on holidays as the condition of the place. The traffic characteristic at the intersection can be obtained from, for example, a database (not illustrated) that stores an analysis result of the traffic characteristic. The search unit 114 searches the recruitment information, and extracts a multifunction pole installed in a place where a traffic characteristic indicates a designated traffic characteristic. In addition, in a case where the size and weight of the device or module desired to be installed by the user are designated, the search unit 114 extracts the multifunction pole whose designated size and weight satisfy the condition of the device in the recruitment information.

In a case where a function desired to be used is specified in the search request, the search unit 114 extracts a multifunction pole capable of providing the function specified by the user. For example, in a case where the user designates a 4K camera or a sensor such as light detection and ranging (LiDAR) as a function to be used, the search unit 114 extracts a multifunction pole that can be used by the designated sensor. The sensor data output by the sensor can be used in a device incorporated by a user. The recruitment information may include a fee to be paid to the pole installer when incorporating the device or module into the multifunction pole. The fee may vary depending on the place in which the multifunction pole is installed, or the like. The user may specify an upper limit value of the fee in the search request. In that case, the search unit 114 extracts a multifunction pole into which a device or a module can be incorporated at a fee equal to or less than the amount of money designated by the user. The search unit 114 corresponds to the search means 12 illustrated in FIG. 1.

The presentation unit 115 transmits the information regarding the multifunction pole extracted by the search unit 114 to the user terminal 140. The user terminal 140 displays the received information regarding the multifunction pole on the screen, and presents to the user which multifunction pole the device or module can be incorporated into. The user can select, from the presented multifunction poles, the multifunction pole into which the device or module is to be incorporated. The user terminal 140 transmits information for identifying the multifunction pole selected by the user to the presentation unit 115. In a case where the user selects the multifunction pole on which the device or the module is installed, the presentation unit 115 transmits information regarding the device or the module desired to be installed by the user to the pole installer who installed the selected multifunction pole. The presentation unit 115 corresponds to the presentation means 13 illustrated in FIG. 1.

The pole installer terminal 130 receives, from the server 110, information regarding a device or a module that the user desires to install. The pole installer determines whether or not to permit to incorporate the device or module described to be installed by the user into the multifunction pole. After completion of the contract or the like, the pole installer receives the device or module from the user, and installs the multifunction pole in which the device or module received from the user is incorporated. Alternatively, the pole installer adds the device or module received from the user to the multifunction pole that has already been installed.

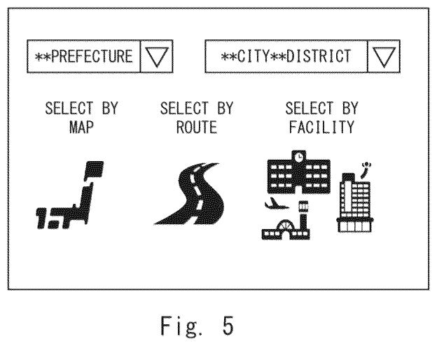

FIG. 5 illustrates an example of a screen displayed on the user terminal 140 in the search. In the example of FIG. 5, the search screen includes an item for specifying a search range and an item for specifying a search method. For example, the search acceptance unit 113 causes the user to designate a prefecture and a municipality on the search screen illustrated in FIG. 5. In addition, the search acceptance unit 113 causes the user to designate a search method. The user designates an area in a somewhat rough range such as a municipality on the search screen, and designates a search method.

For example, when the user selects “select by map” on the search screen, the search acceptance unit 113 displays a map of the vicinity of the municipality designated by the user on the display screen of the user terminal 140. The user specifies a geographical range of a place where the user wants to install the device on the displayed map using a lasso tool or the like. When the user designates the geographical range, the search acceptance unit 113 sets the designated geographical range as the search range. In the recruitment information, the search unit 114 extracts one or more multifunction poles whose location information indicates a location within the search range.

When the user selects “select by route” on the search screen, the search acceptance unit 113 displays a route name of a road or the like in the vicinity of the municipality designated by the user on the display screen of the user terminal 140. The search acceptance unit 113 displays, for example, national roads, prefectural roads, and municipal roads on the display screen of the user terminal 140. The user can designate a route in which the device is desired to be installed from the displayed route name. When the user route is designated, the search acceptance unit 113 sets a place along the designated route as the search range. The search unit 114 extracts a multifunction pole indicating a place along the route for which the location information is designated in the recruitment information.

In a case where the user selects “select by facility” on the search screen, the search acceptance unit 113 displays facility names or facility genres of facilities existing in the vicinity of the municipality designated by the user on the display screen of the user terminal 140. In a case where the genre is selected, the search acceptance unit 113 displays genre names such as schools, stations, commercial facilities. In a case where the user selects the genre name, the search acceptance unit 113 displays the facility name of the facility of the selected genre existing in the vicinity of the municipality designated by the user. The user can designate a facility in which the device is desired to be installed from the displayed facility name. In a case where the user designates a facility, the search acceptance unit 113 sets a predetermined range centered on the designated facility as the search range. In the recruitment information, the search unit 114 extracts a multifunction pole whose location information indicates a location within the search range.

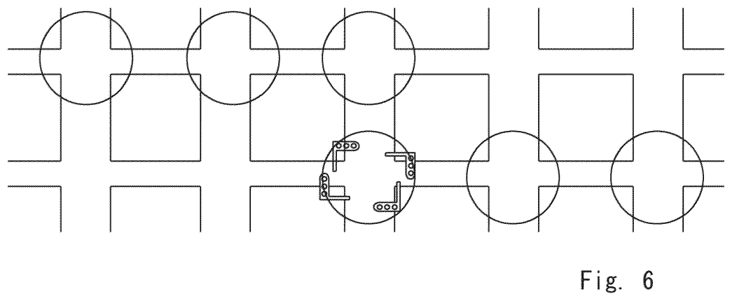

FIG. 6 illustrates a display example of the search result displayed on the user terminal 140 by the presentation unit 115. For example, in a case where a plurality of multifunction poles is extracted by the search unit 114, the presentation unit 115 groups the multifunction poles in units of intersections. The user terminal 140 displays the intersection corresponding to each group on the map, and presents the intersection where the multifunction pole into which the device or the module can be incorporated is installed to the user. In the example of FIG. 6, a circled intersection indicates an intersection at which the extracted multifunction pole is installed.

The user selects an intersection at which the user wants to incorporate a desired device or module into the multifunction pole on the displayed map. In a case where the user selects a desired intersection, the user terminal 140 displays a multifunction pole installed at the intersection. That is, the user terminal 140 displays the multifunction pole of the group corresponding to the intersection selected by the user. In the example of FIG. 6, the user terminal 140 displays four multifunction poles (traffic lights) installed at the intersection selected by the user. The presentation unit 115 causes the user to designate, at the selected intersection, a multifunction pole that incorporates the device or module. From the four multifunction poles, a user can designate one or more multifunction poles as multifunction poles that incorporate the desired device or modules. The user may also select a plurality of intersections and designate the multifunction poles installed at the plurality of intersections as multifunction poles that incorporate desired device or modules.

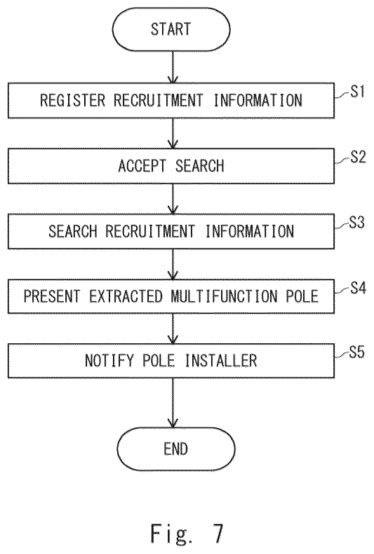

Next, an operation procedure will be described. FIG. 7 illustrates an operation procedure (device installation support method) in the server 110. The registration unit 111 receives the recruitment information from the pole installer terminal 130. The registration unit 111 can receive recruitment information for a plurality of multifunction poles from a plurality of pole installers. The registration unit 111 registers the recruitment information in the recruitment information storage unit 112 (Step S1).

The search acceptance unit 113 accepts, from the user terminal 140, a search for a multifunction pole into which a desired device or module can be incorporated (Step S2). The search unit 114 searches the recruitment information, and extracts a multifunction pole into which a device or a module desired to be installed by the user can be incorporated (Step S3). The presentation unit 115 transmits information for identifying the multifunction pole extracted in the search in Step S3 to the user terminal 140, and presents the extracted multifunction pole to the user (Step S4). The user selects, from the presented multifunction poles, the multifunction pole on which the user wishes to install the device or module. In a case where the user selects the multifunction pole, the presentation unit 115 notifies the pole installer of the selected multifunction pole of information regarding the user who wants to incorporate the device or module, and information regarding the type, size, and weight of the device or module, or the like (Step S5).

For example, in a case where a multifunction pole is installed as a traffic signal pole, it is considered that the installation company is determined by public recruitment for each intersection, similarly to a normal traffic signal pole. When it is attempted to add a function to a multifunction pole (multifunction traffic signal pole), it is considered that it is necessary to solicit a module having what function at which intersection separately from the recruitment of multifunction traffic signal poles. In the present example embodiment, the pole installer registers the recruitment information in the server 110, and the device installation desiring person requests the server 110 to search the recruitment information. The server 110 extracts a multifunction pole into which a device or a module desired to be installed by the device installation desiring person can be incorporated, and presents the extracted multifunction pole to the device installation desiring person. In the present example embodiment, even when the pole installer is different for each intersection, the server 110 can linearly or planarly extract the multifunction pole into which the device or module desired to be installed by the device installation desiring person can be incorporated. The server 110 can perform supply and demand matching between an installation company of a plurality of multifunction poles and a device installation desiring person who wishes to incorporate a device into the multifunction poles at a plurality of intersections, and can support the installation of the device in the multifunction poles.

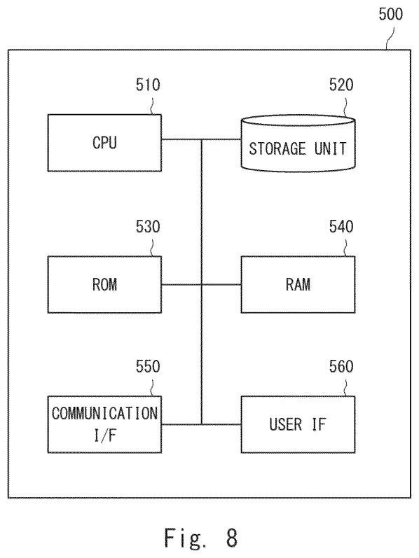

Next, an example of a hardware configuration of the server 110 (device installation support apparatus) will be described. FIG. 8 illustrates a configuration example of a computer device that can be used as the server 110. The computer device 500 includes a control unit (central processing unit (CPU)) 510, a storage unit 520, a read only memory (ROM) 530, a random access memory (RAM) 540, a communication interface (interface (IF)) 550, and a user interface 560.

The communication interface 550 is an interface for connecting the computer device 500 to a communication network through wired communication means, wireless communication means, or the like. The user interface 560 includes, for example, a display unit such as a display. Further, the user interface 560 includes an input unit such as a keyboard, a mouse, and a touch panel.

The storage unit 520 is an auxiliary storage device that can hold various types of data. The storage unit 520 is not necessarily a part of the computer device 500, and may be an external storage device or a cloud storage connected to the computer device 500 via a network.

The ROM 530 is a nonvolatile storage device. For example, a semiconductor storage device such as a flash memory having a relatively small capacity may be used for the ROM 530. A program that is executed by the CPU 510 may be stored in the storage unit 520 or the ROM 530. The storage unit 520 or the ROM 530 stores, for example, various programs for realizing at least some of the functions of the respective units in the server 110.

The program includes a group of instructions (or software codes) for causing a computer to perform one or more functions that have been described in the example embodiments when the program is read by the computer. The program may be stored in a non-transitory computer-readable medium or a tangible storage medium. As an example and not by way of limitation, a computer-readable medium or tangible storage medium includes a RAM, a ROM, a flash memory, a solid-state drive (SSD) or other memory technology, a compact disc (CD), a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. As an example and not by way of limitation, the transitory computer-readable medium or the communication medium includes an electrical signal, an optical signal, an acoustic signal, or other forms of propagation signals.

The RAM 540 is a volatile storage device. As the RAM 540, various types of semiconductor memory devices such as a dynamic random access memory (DRAM) or a static random access memory (SRAM) may be used. The RAM 540 may be used as an internal buffer for temporarily storing data or the like. The CPU 510 loads a program stored in the storage unit 520 or the ROM 530 in the RAM 540, and executes the loaded program. The function of each unit in the server 110 can be realized by the CPU 510 executing the programs. The CPU 510 may include an internal buffer in which data or the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure. For example, a portion or the entirety of the above example embodiment may be described as the following supplementary notes, but are not limited to the following.

### Supplementary Note 1

A device installation support apparatus including:
a registration means for registering, for a multifunction pole to be installed or installed, recruitment information for recruiting addition of a device to the multifunction pole;
a search means for searching the recruitment information and extracting a multifunction pole into which a device desired to be installed by a user or a module incorporating the device can be incorporated; and
a presentation means for presenting the extracted multifunction pole to the user.

### Supplementary Note 2

The device installation support apparatus according to Supplementary Note 1, in which
the recruitment information includes location information of the multifunction pole,
the user designates a condition of a place where the user desires to install the device or the module in the search means, and
the search means extracts a multifunction pole whose location information matches the condition of the place.

### Supplementary Note 3

The device installation support apparatus according to Supplementary Note 2, in which
the user designates a facility as the condition of the place, and
the search means extracts a multifunction pole whose location information indicates a location within a predetermined range from the designated facility.

### Supplementary Note 4

The device installation support apparatus according to Supplementary Note 2 or 3, in which
the user designates a route as the condition of the place, and
the search means extracts a multifunction pole whose location information indicates a location of the designated route.

### Supplementary Note 5

The device installation support apparatus according to any one of Supplementary Notes 2 to 4, in which
the user designates a geographical range as the condition of the place, and
the search means extracts a multifunction pole whose location information indicates a location within the designated geographical range.

### Supplementary Note 6

The device installation support apparatus according to any one of Supplementary Notes 2 to 5, in which
the user designates a traffic characteristic as the condition of the place, and
the search means extracts a multifunction pole whose location information indicates the designated traffic characteristic.

### Supplementary Note 7

The device installation support apparatus according to any one of Supplementary Notes 1 to 6, in which
the recruitment information further includes information indicating a function that can be provided by the multifunction pole, and
the user designates a function desired to be provided from the multifunction pole to the search means.

### Supplementary Note 8

The device installation support apparatus according to any one of Supplementary Notes 1 to 7, in which
the recruitment information includes at least one of a condition of a device that can be incorporated into the multifunction pole and a condition of a module that can be incorporated into the multifunction pole, and
the search means extracts a multifunction pole in which a device or a module desired to be installed by the user satisfies the condition of the device or the condition of the module.

### Supplementary Note 9

The device installation support apparatus according to supplementary note 8, in which
the condition of the device and the condition of the module include at least one of a size and a weight of the device or the module, and
the search means extracts a multifunction pole in which at least one of a size and a weight of the device or the module desired to be installed by the user satisfies the condition of the device or the condition of the module.

### Supplementary Note 10

The device installation support apparatus according to any one of Supplementary Notes 1 to 9, in which when the user selects a multifunction pole in which a device or a module is to be installed from the presented multifunction pole, the presentation means transmits information regarding the device or the module that the user desires to install to an installer of the selected multifunction pole.

### Supplementary Note 11

The device installation support apparatus according to any one of Supplementary Notes 1 to 10, in which in a case where a plurality of multifunction poles is extracted by the search means, the presentation means groups the plurality of multifunction poles in units of intersections, presents an intersection corresponding to each group to the user, and causes the user to designate a multifunction pole at which the user desires to install a device or a module at the presented intersection.

### Supplementary Note 12

A device installation support method including:
registering, for a multifunction pole to be installed or installed, recruitment information for recruiting addition of a device to the multifunction pole;
searching the recruitment information and extracting a multifunction pole into which a device desired to be installed by a user or a module incorporating the device can be incorporated; and
presenting the extracted multifunction pole to the user.

### Supplementary Note 13

A non-transitory computer-readable medium storing a program for causing a computer to execute processing including:
registering, for a multifunction pole to be installed or installed, recruitment information for recruiting addition of a device to the multifunction pole;
searching the recruitment information and extracting a multifunction pole into which a device desired to be installed by a user or a module incorporating the device can be incorporated; and
presenting the extracted multifunction pole to the user.

### REFERENCE SIGNS LIST

10 DEVICE INSTALLATION SUPPORT APPARATUS
11 REGISTRATION MEANS
12 SEARCH MEANS
13 PRESENTATION MEANS
100 DEVICE INSTALLATION SUPPORT SYSTEM
110 SERVER (DEVICE INSTALLATION SUPPORT APPARATUS)
111 REGISTRATION UNIT
112 RECRUITMENT INFORMATION STORAGE UNIT
113 SEARCH ACCEPTANCE UNIT
114 SEARCH UNIT
115 PRESENTATION UNIT
130 POLE INSTALLER TERMINAL
140 USER TERMINAL
500 COMPUTER DEVICE
510 CPU
520 STORAGE UNIT
530 ROM
540 RAM
550 COMMUNICATION IF
560 USER IF

What is claimed is:

1. A device installation support apparatus comprising:
at least one memory storing instructions; and
at least one processor configured to execute the instructions to:
register, for a multifunction pole to be installed or installed, recruitment information for recruiting addition of a device to the multifunction pole;
search the recruitment information and extract a multifunction pole into which a device desired to be installed by a user or a module incorporating the device can be incorporated; and
present the extracted multifunction pole to the user.

2. The device installation support apparatus according to claim 1, wherein
the recruitment information includes location information of the multifunction pole,
the user designates a condition of a place where the user desires to install the device or the module as a condition for searching the recruitment information, and
the at least on processor is configured to execute the instructions to extract a multifunction pole whose location information matches the condition of the place.

3. The device installation support apparatus according to claim 2, wherein
the user designates a facility as the condition of the place, and
the at least on processor is configured to execute the instructions to extract a multifunction pole whose location information indicates a location within a predetermined range from the designated facility.

4. The device installation support apparatus according to claim 2, wherein
the user designates a route as the condition of the place, and
the at least on processor is configured to execute the instructions to extract a multifunction pole whose location information indicates a location of the designated route.

5. The device installation support apparatus according to claim 2, wherein
the user designates a geographical range as the condition of the place, and
the at least on processor is configured to execute the instructions to extract a multifunction pole whose location information indicates a location within the designated geographical range.

6. The device installation support apparatus according to claim 2, wherein
the user designates a traffic characteristic as the condition of the place, and
the at least on processor is configured to execute the instructions to extract a multifunction pole whose location information indicates the designated traffic characteristic.

7. The device installation support apparatus according to claim 1, wherein
the recruitment information further includes information indicating a function that can be provided by the multifunction pole, and
the user designates a function desired to be provided from the multifunction pole as a condition for searching the recruitment information.

8. The device installation support apparatus according to claim 1, wherein
the recruitment information includes at least one of a condition of a device that can be incorporated into the multifunction pole or a condition of a module that can be incorporated into the multifunction pole, and
the at least on processor is configured to execute the instructions to extract a multifunction pole in which a device or a module desired to be installed by the user satisfies a condition of the device or a condition of the module.

9. The device installation support apparatus according to claim 8, wherein
the condition of the device and the condition of the module include at least one of a size or a weight of the device or the module, and
the at least on processor is configured to execute the instructions to extract a multifunction pole in which at least one of a size or a weight of the device or the module desired to be installed by the user satisfies the condition of the device or the condition of the module.

10. The device installation support apparatus according to claim 1, wherein when the user selects a multifunction pole in which a device or a module is to be installed from the presented multifunction pole, the at least on processor is configured to execute the instructions to transmit information regarding the device or the module that the user desires to install to an installer of the selected multifunction pole.

11. The device installation support apparatus according to claim 1, wherein in a case where a plurality of multifunction poles is extracted, the at least on processor is configured to execute the instructions to group the plurality of multifunction poles in units of intersections, present an intersection corresponding to each group to the user, and cause the user to designate a multifunction pole at which the user desires to install a device or a module at the presented intersection.

12. A device installation support method comprising:
registering, for a multifunction pole to be installed or installed, recruitment information for recruiting addition of a device to the multifunction pole;
searching the recruitment information and extracting a multifunction pole into which a device desired to be installed by a user or a module incorporating the device can be incorporated; and
presenting the extracted multifunction pole to the user.

13. A non-transitory computer-readable medium storing a program for causing a computer to execute processing including:
registering, for a multifunction pole to be installed or installed, recruitment information for recruiting addition of a device to the multifunction pole;
searching the recruitment information and extracting a multifunction pole into which a device desired to be installed by a user or a module incorporating the device can be incorporated; and
presenting the extracted multifunction pole to the user.
